(19) United States
(12) Patent Application Publication
(10) Pub. No.: US 2003/0138045 A1
(43) Pub. Date: Jul. 24, 2003

(54) Video decoder with scalable architecture

(75) Inventors: John Murdock, Apalachin, NY (US); Agnes Y. Ngai, Endwell, NY (US); Edward F. Westermann, Endicott, NY (US)

Correspondence Address: Kevin P. Radigan, Esq., Heslin Rothenberg Farley & Mesiti P.C., 5 Columbia Circle, Albany, NY, 12203, US

(73) Assignee: International Business Machines Corporation, Armonk, NY

(21) Appl. No.: 10/051,436

(22) Filed: Jan. 18, 2002

(51) Int. Cl. H04N 7/12

(52) U.S. Cl. 375/240.12; 375/240.24; 375/240.25

(57) ABSTRACT

A scalable architecture for a video decode system is provided for facilitating decoding of an encoded stream of video frames, such as a high definition (HD) bitstream. The architecture comprises multiple decoders connected in parallel to receive the encoded stream of video frames. Each decoder selects and decodes a respective portion of each frame of the bitstream, wherein cumulatively the respective portions decoded by the multiple decoders constitute the entire frame. In one embodiment, the decoders are standard definition (SD) decoders.

### CROSS-REFERENCE TO RELATED APPLICATIONS

This application contains subject matter which is related to the subject matter of the following United States applications/patents, which are assigned to the same assignee as this application. Each of the below listed applications/patents is hereby incorporated herein by reference in its entirety:

“Anti-Flicker Logic For MPEG Video Decoder With Integrated Scaling and Display Functions”, by D. Hrusecky, U.S. Ser. No. 09/237,600, filed Jan. 25, 1999;

“Multi-Format Reduced Memory MPEG-2 Compliant Decoder”, by Cheney, et al., U.S. Pat. No. 5,929,911, issued Jul. 27, 1999;

“Multi-Format Reduced Memory Video Decoder With Adjustable Polyphase Expansion Filter”, by D. Hrusecky, U.S. Pat. No. 5,973,740, issued Oct. 26, 1999;

“Multi-Format Reduced Memory MPEG Decoder With Hybrid Memory Address Generation”, by Cheney et al., U.S. Pat. No. 5,963,222, issued Oct. 5, 1999;

“Compression/Decompression Engine For Enhanced Memory Storage In MPEG Decoder”, by Buerkle et al., U.S. Pat. No. 6,157,740, issued Dec. 5, 2000.

### FIELD OF THE INVENTION

The present invention relates to digital video signal processing, and more particularly, to integrated decode systems, methods and articles of manufacture which facilitate, for example, decoding of a high definition (HD) bitstream employing multiple standard definition (SD) decoders.

### BACKGROUND OF THE INVENTION

The MPEG-2 standard describes an encoding method that results in substantial bandwidth reduction via subjective lossy compression followed by lossless compression. The encoded, compressed digital data is subsequently decompressed and decoded in an MPEG-2 compliant decoder. Video decoding in accordance with the MPEG-2 standard is described in detail in commonly assigned U.S. Pat. No. 5,576,765, entitled “Video Decoder” which is hereby incorporated herein by reference in its entirety.

High definition video is continuing to increase in popularity. A typical high definition (HD) picture contains 1920×1088 pixels, while a standard definition (SD) image contains only 720×480. Current technology is unable to provide a single HD codec for encoding/decoding in realtime an HD bitstream.

A need thus remains in the art for an enhanced decode system which is able to process an HD bitstream in realtime within the constraints of available technology.

### SUMMARY OF THE INVENTION

The shortcomings of the prior art are overcome and additional advantages are provided through the provision of a method of decoding a frame of an encoded stream of video frames. The method includes: forwarding an encoded stream of video frames to multiple decode processes in parallel; decoding at least one frame of the encoded stream of video frames employing the multiple decode processes; and wherein for each frame of the at least one frame, each decode process of the multiple decode processes selects and decodes a respective portion of the frame. Cumulatively the respective portions decoded by the multiple decode processes constitute the entire frame.

In enhanced aspects, each decode process of the multiple decode processes discards portions of the frame being decoded outside of its respective portion to decode. A host interface forwards the encoded stream of video frames to the multiple decode processes in parallel without predividing the encoded stream of video frames. The method also includes exchanging motion overlap data between decode processes decoding adjacent respective portions of the frame, and commensurate therewith, synchronizing decoding of the encoded stream of video frames.

Systems and computer program products corresponding to the above-summarized methods are also described and claimed herein.

To restate, presented herein is a video decode system with a scalable architecture. The video decode system permits the use of standard definition decoders to handle high definition video decode. Advantageously, the decode system presented herein offers high definition decode capabilities while eliminating idle circuitry in a multi-chip integrated encoder and decoder (codec) system as proposed herein. Further, the decode system presented offers realtime decoding of an HD bitstream. Any need for front-end processing to divide an HD bitstream into portions to be distributed to the various decoders is avoided with the decode system implementation presented herein. The issue of reference-data fetch overlap is also addressed by a bus interface structure which allows for communication between adjacent decoders, and enables synchronization among the decoders between pictures, thereby simplifying buffering of the decoded pictures for display.

Additional features and advantages are realized through the techniques of the present invention. Other embodiments and aspects of the invention are described in detail herein and are considered a part of the claimed invention

### BRIEF DESCRIPTION OF THE DRAWINGS

The above-described objects, advantages and features of the present invention, as well as others, will be more readily understood from the following detailed description of certain preferred embodiments of the invention, when considered in conjunction with the accompanying drawings in which:

FIG. 1 shows an exemplary pair of groups of pictures (GOPs);

FIG. 2 shows an exemplary macroblock (MB) subdivision of a picture (4:2:0 format);

FIG. 3 depicts a block diagram of a video decoder;

FIG. 4 is block diagram of a video decoding system to employ aspects of the present invention;

FIG. 5 is a block diagram of one embodiment of a video decode system with scalable architecture, in accordance with an aspect of the present invention;

FIGS. 6A & 6B show one embodiment of decode logic for decoding an encoded stream of video data, in accordance with an aspect of the present invention;

FIG. 7 depicts one embodiment of a data exchange interface between DECᵢ and DECᵢ₊₁, in accordance with an aspect of the present invention;

FIG. 8 depicts decoded pixel data of an I or P picture to be exchanged between adjacent decoders at boundaries of a respective decoded portion, in accordance with an aspect of the present invention; and

FIGS. 9A & 9B depict one embodiment of exchanging decoded pixel data between adjacent decoders pursuant to a command structure, in accordance with an aspect of the present invention.

### BEST MODE FOR CARRYING OUT THE INVENTION

As the present invention may be applied in connection with (for example) an MPEG-2 decoder, in order to facilitate an understanding of the invention, certain aspects of the MPEG-2 compression algorithm are first reviewed. It is to be noted, however, that the invention can also be applied to other video coding algorithms.

To begin with, it will be understood that the compression of a data object, such as a page of text, an image, a segment of speech, or a video sequence, can be thought of as a series of steps, including: 1) a decomposition of that object into a collection of tokens; 2) the representation of those tokens by binary strings which have minimal length in some sense; and 3) the concatenation of the strings in a well-defined order. Steps 2 and 3 are lossless, i.e., the original data is faithfully recoverable upon reversal, and Step 2 is known as entropy coding. Step 1 can be either lossless or lossy in general. Most video compression algorithms are lossy because of stringent bit-rate requirements. A successful lossy compression algorithm eliminates redundant and irrelevant information, allowing relatively large errors where they are not likely to be visually significant and carefully representing aspects of a sequence to which the human observer is very sensitive. The techniques employed in the MPEG-2 algorithm for Step 1 can be described as predictive/interpolative motion-compensated hybrid DCT/DPCM coding. Huffman coding, also known as variable length coding, is used in Step 2.

The MPEG-2 video standard specifies a coded representation of video for transmission as set forth in ISO-IEC JTC1/SC29/WG11, Generic Coding of Moving Pictures and Associated Audio Information: Video, International Standard, 1994. The algorithm is designed to operate on interlaced or non-interlaced component video. Each picture has three components: luminance (Y), red color difference (Cr), and blue color difference (Cb). The video data may be coded in 4:4:4 format, in which case there is one Cr and one Cb sample for each Y sample, in 4:2:2 format, in which case there are half as many Cr and Cb samples as luminance samples in the horizontal direction, or in 4:2:0 format, in which case there are half as many Cr and Cb samples as luminance samples in both the horizontal and vertical directions.

An MPEG-2 data stream consists of a video stream and an audio stream which are packed, together with systems information and possibly other bitstreams, into a systems data stream that can be regarded as layered. Within the video layer of the MPEG-2 data stream, the compressed data is further layered. A description of the organization of the layers will aid in understanding the invention. These layers of the MPEG-2 Video Layered Structure are shown in FIGS. 1 & 2. The layers pertain to the operation of the compression algorithm as well as the composition of a compressed bitstream. The highest layer is the Video Sequence Layer, containing control information and parameters for the entire sequence. At the next layer, a sequence is subdivided into sets of consecutive pictures, each known as a “Group of Pictures” (GOP). A general illustration of this layer is shown in FIG. 1. Decoding may begin at the start of any GOP, essentially independent of the preceding GOPs. There is no limit to the number of pictures which may be in a GOP, nor do there have to be equal numbers of pictures in all GOPs.

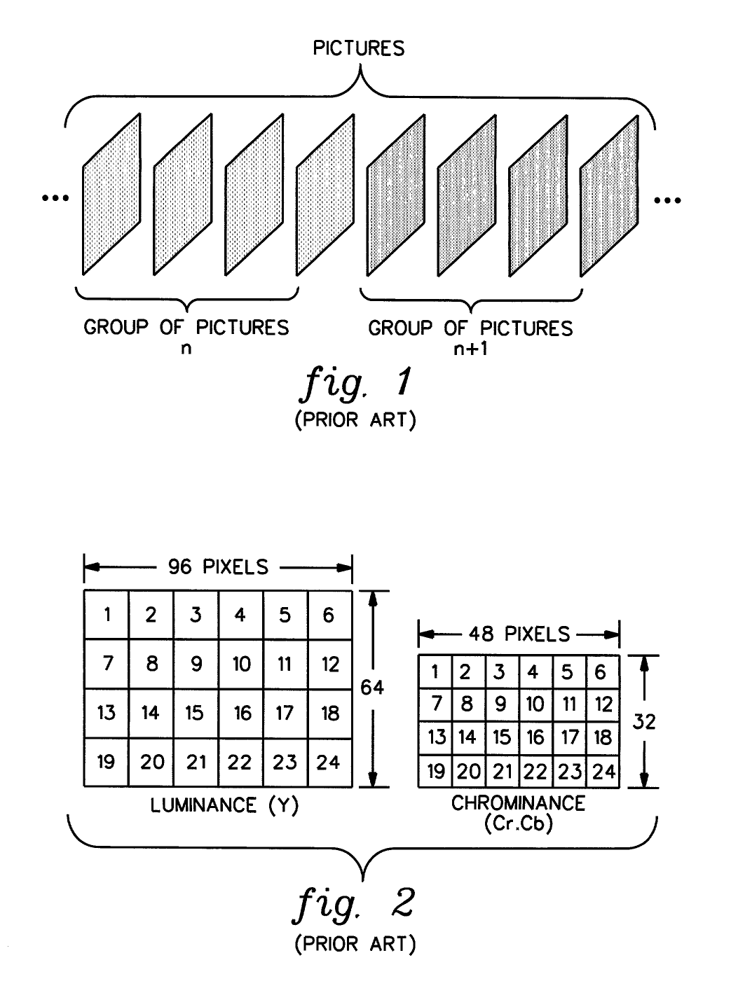

The third or Picture layer is a single picture. A general illustration of this layer is shown in FIG. 2. The luminance component of each picture is subdivided into 16×16 regions; the color difference components are subdivided into appropriately sized blocks spatially co-sited with the 16×16 luminance regions; for 4:4:4 video, the color difference components are 16×16, for 4:2:2 video, the color difference components are 8×16, and for 4:2:0 video, the color difference components are 8×8. Taken together, these co-sited luminance region and color difference regions make up the fifth layer, known as a “macroblock” (MB). Macroblocks in a picture are numbered consecutively in lexicographic order, starting with Macroblock 1.

Between the Picture and MB layers is the fourth or “slice” layer. Each slice consists of some number of consecutive MB's. Finally, each MB consists of four 8×8 luminance blocks and 8, 4, or 2 (for 4:4:4, 4:2:2 and 4:2:0 video) chrominance blocks. The Sequence, GOP, Picture, and slice layers all have headers associated with them. The headers begin with byte-aligned Start Codes and contain information pertinent to the data contained in the corresponding layer.

A picture can be either field-structured or frame-structured. A frame-structured picture contains information to reconstruct an entire frame, i.e., the combination of one field containing the odd lines and the other field containing the even lines. A field-structured picture contains information to reconstruct one field. If the width of each luminance frame (in picture elements or pixels) is denoted as C and the height as R (C is for columns, R is for rows), a field-structured picture contains information for C×R/2 pixels.

The two fields in a frame are the top field and the bottom field. If we number the lines in a frame starting from 1, then the top field contains the odd lines (1, 3, 5, . . . ) and the bottom field contains the even lines (2, 4, 6, . . . ). Thus we may also call the top field the odd field, and the bottom field the even field.

A macroblock in a field-structured picture contains a 16×16 pixel segment from a single field. A macroblock in a frame-structured picture contains a 16×16 pixel segment from the frame that both fields compose; each macroblock contains a 16×8 region from each of the two fields.

Within a GOP, three types of pictures can appear. The distinguishing difference among the picture types is the compression method used. The first type, Intramode pictures or I-pictures, are compressed independently of any other picture. Although there is no fixed upper bound on the distance between I-pictures, it is expected that they will be interspersed frequently throughout a sequence to facilitate random access and other special modes of operation. Predictively motion-compensated pictures (P pictures) are reconstructed from the compressed data in that picture plus two reconstructed fields from previously displayed I or P pictures. Bidirectionally motion-compensated pictures (B pictures) are reconstructed from the compressed data in that picture plus two reconstructed fields from previously displayed I or P pictures and two reconstructed fields from I or P pictures that will be displayed in the future. Because reconstructed I or P pictures can be used to reconstruct other pictures, they are called reference pictures.

With the MPEG-2 standard, a frame can be coded either as a frame-structured picture or as two field-structured pictures. If a frame is coded as two field-structured pictures, then both fields can be coded as I pictures, the first field can be coded as an I picture and the second field as a P picture, both fields can be coded as P pictures, or both fields can be coded as B pictures.

If a frame is coded as a frame-structured I picture, as two field-structured I pictures, or as a field-structured I picture followed by a field-structured P picture, we say that the frame is an I frame; it can be reconstructed without using picture data from previous frames. If a frame is coded as a frame-structured P picture or as two field-structured P pictures, we say that the frame is a P frame; it can be reconstructed from information in the current frame and the previously coded I or P frame. If a frame is coded as a frame-structured B picture or as two field-structured B pictures, we say that the frame is a B frame; it can be reconstructed from information in the current frame and the two previously coded I or P frames (i.e., the I or P frames that will appear before and after the B frame). We refer to I or P frames as reference frames.

A common compression technique is transform coding. In MPEG-2 and several other compression standards, the discrete cosine transform (DCT) is the transform of choice. The compression of an I-picture is achieved by the steps of 1) taking the DCT of blocks of pixels, 2) quantizing the DCT coefficients, and 3) Huffman coding the result. In MPEG-2, the DCT operation converts a block of n n pixels into an n×n set of transform coefficients. Like several of the international compression standards, the MPEG-2 algorithm uses a DCT block size of 8×8. The DCT transformation by itself is a lossless operation, which can be inverted to within the precision of the computing device and the algorithm with which it is performed.

The second step, quantization of the DCT coefficients, is the primary source of lossiness in the MPEG-2 algorithm. Denoting the elements of the two-dimensional array of DCT coefficients by cmn, where m and n can range from 0 to 7, aside from truncation or rounding corrections, quantization is achieved by dividing each DCT coefficient cmn by (wmn times QP), with wmn being a weighting factor and QP being the quantizer parameter. The weighting factor wmn allows coarser quantization to be applied to the less visually significant coefficients. The quantizer parameter QP is the primary means of trading off quality vs. bit-rate in MPEG-2. It is important to note that QP can vary from MB to MB within a picture.

Following quantization, the DCT coefficient information for each MB is organized and coded, using a set of Huffman codes. As the details of this step are not essential to an understanding of the invention and are generally understood in the art, no further description is needed here.

Most video sequences exhibit a high degree of correlation between consecutive pictures. A useful method to remove this redundancy prior to coding a picture is “motion compensation”. MPEG-2 provides tools for several methods of motion compensation.

The methods of motion compensation have the following in common. For each macroblock, one or more motion vectors are encoded in the bitstream. These motion vectors allow the decoder to reconstruct a macroblock, called the predictive macroblock. The encoder subtracts the “predictive” macroblock from the macroblock to be encoded to form the “difference” macroblock. The encoder uses tools to compress the difference macroblock that are essentially similar to the tools used to compress an intra macroblock.

The type of a picture determines the methods of motion compensation that can be used. The encoder chooses from among these methods for each macroblock in the picture. If no motion compensation is used, the macroblock is intra (I). The encoder can make any macroblock intra. In a P or a B picture, forward (F) motion compensation can be used; in this case, the predictive macroblock is formed from data in the previous I or P frame. In a B picture, backward (B) motion compensation can also be used; in this case, the predictive macroblock is formed from data in the future I or P frame. In a B picture, forward/backward (FB) motion compensation can also be used; in this case, the predictive macroblock is formed from data in the previous I or P frame and the future I or P frame.

Because I and P pictures are used as references to reconstruct other pictures (B and P pictures) they are called reference pictures. Because two reference frames are needed to reconstruct B frames, MPEG-2 decoders typically store two decoded reference frames in memory.

Aside from the need to code side information relating to the MB mode used to code each MB and any motion vectors associated with that mode, the coding of motion-compensated macroblocks is very similar to that of intramode MBs. Although there is a small difference in the quantization, the model of division by wmn times QP still holds.

The MPEG-2 algorithm can be used with fixed bit-rate transmission media. However, the number of bits in each picture will not be exactly constant, due to the different types of picture processing, as well as the inherent variation with time of the spatio-temporal complexity of the scene being coded. The MPEG-2 algorithm uses a buffer-based rate control strategy to put meaningful bounds on the variation allowed in the bit-rate. A Video Buffer Verifier (VBV) is devised in the form of a virtual buffer, whose sole task is to place bounds on the number of bits used to code each picture so that the overall bit-rate equals the target allocation and the short-term deviation from the target is bounded. This rate control scheme can be explained as follows. Consider a system consisting of a buffer followed by a hypothetical decoder. The buffer is filled at a constant bit-rate with compressed data in a bitstream from the storage medium. Both the buffer size and the bit-rate are parameters which are transmitted in the compressed bitstream. After an initial delay, which is also derived from information in the bitstream, the hypothetical decoder instantaneously removes from the buffer all of the data associated with the first picture. Thereafter, at intervals equal to the picture rate of the sequence, the decoder removes all data associated with the earliest picture in the buffer.

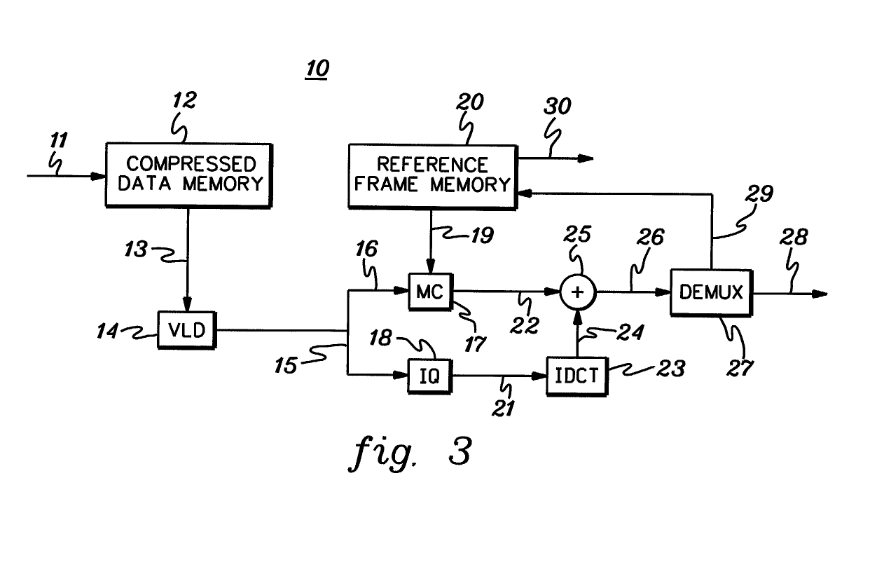

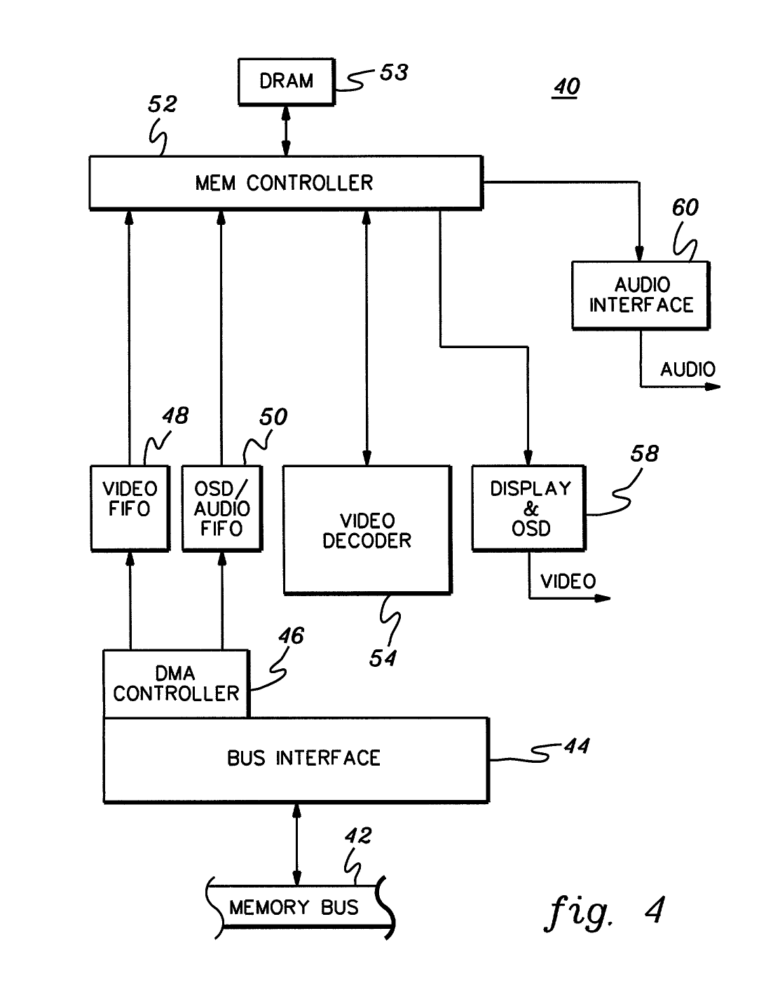

FIG. 3 shows a diagram of a conventional video decoder. The compressed data enters as signal 11 and is stored in the compressed data memory 12. The variable length decoder (VLD) 14 reads the compressed data as signal 13 and sends motion compensation information as signal 16 to the motion compensation (MC) unit 17 and quantized coefficients as signal 15 to the inverse quantization (IQ) unit 18. The motion compensation unit reads the reference data from the reference frame memory 20 as signal 19 to form the predicted macroblock, which is sent as the signal 22 to the adder 25. The inverse quantization unit computes the unquantized coefficients, which are sent as signal 21 to the inverse transform (IDCT) unit 23. The inverse transform unit computes the reconstructed difference macroblock as the inverse transform of the unquantized coefficients. The reconstructed difference macroblock is sent as signal 24 to the adder 25, where it is added to the predicted macroblock. The adder 25 computes the reconstructed macroblock as the sum of the reconstructed difference macroblock and the predicted macroblock. The reconstructed macroblock is then sent as signal 26 to the demultiplexer 27, which stores the reconstructed macroblock as signal 29 to the reference memory if the macroblock comes from a reference picture or sends it out (to memory or display) as signal 28. Reference frames are sent out as signal 30 from the reference frame memory.

An embodiment of a decode system, generally denoted 40, is depicted in FIG. 4 System 40 includes a bus interface 44 which couples the decode system 40 to a memory bus 42. MPEG encoded video data is fetched from PCI bus 42 by a DMA controller 46 which writes the data to a video First-In/First-Out (FIFO) buffer 48. The DMA controller also fetches on-screen display and/or audio data from bus 42 for writing to an OSD/audio FIFO 50. A memory controller 52 will place video data into a correct memory buffer within dynamic random access memory (DRAM) 53. MPEG compressed video data is then retrieved by the video decoder 54 from DRAM 53 and decoded as described above in connection with FIG. 3. Conventionally, the decoded video data is then stored back into the frame buffers of DRAM 53 for subsequent use as already described. When a reference frame is needed, or when video data is to be output from the decode system, stored data in DRAM 53 is retrieved by the MEM controller and forwarded for output via a display & OSD interface 58. Audio data, also retrieved by the memory controller 52, is output through an audio interface 60.

As discussed initially herein, this invention addresses the need for a decoding system having a scalable architecture which facilitates decoding of a high definition (HD) video signal using standard definition (SD) technology. As the MPEG-2 video decoder market becomes more and more competitive, the need for a high level of feature integration at a lowest possible cost is important to achieving success in the marketplace. The present invention acknowledges this by providing a scalable architecture for a decode system that utilizes, in one embodiment, chips which may reside in a single integrated high definition encoder and decoder system (or codec).

A typical high definition (HD) frame or picture contains 1920×1088 pixels, while a standard definition (SD) image contains 720×480. A simple calculation shows that a HD image is approximately six times that of an SD image. Thus, in one example, six SD decoders could be used to handle one HD decode operation. Depending on decoder performance capability, however, it is possible to use less than (or even more than) six decoders.

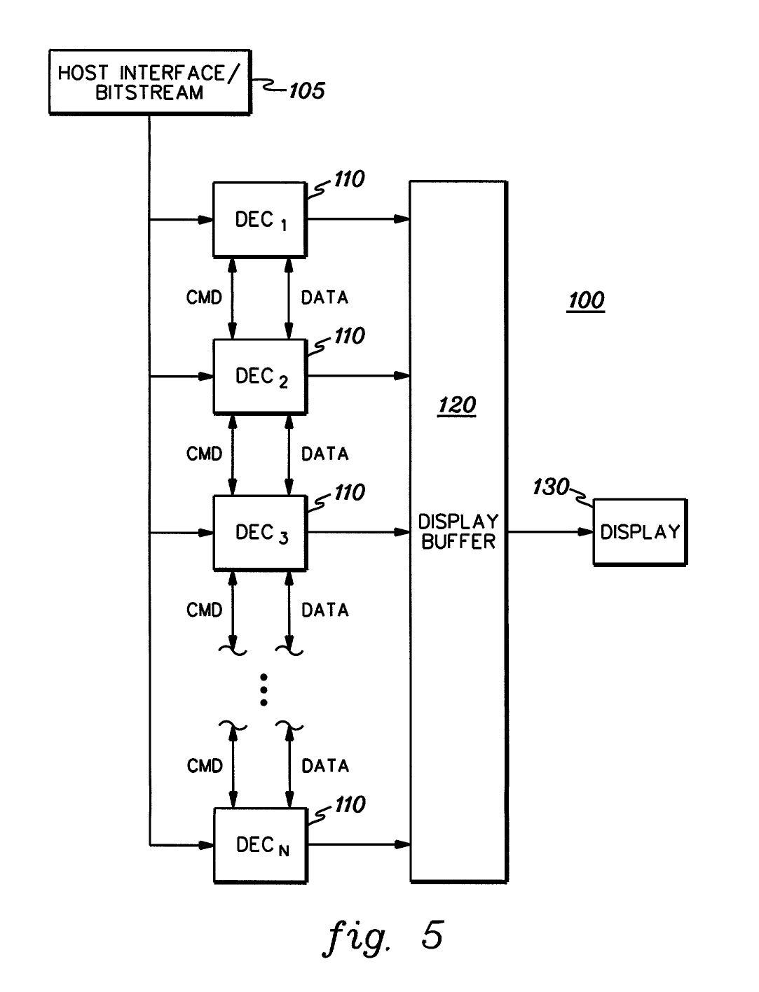

Multiple decoders are employed to decode an HD picture since the performance limitations of the individual decoders prevent a single decoder from being used today. Essentially, the time or bandwidth for a single decoder to decode an HD video in a realtime environment is insufficient. When multiple decoders are connected and operate as one entity, however, the single entity may be used to handle the decode operation of HD video in realtime. FIG. 5 shows one embodiment of multiple decoders or decode processes coupled in parallel to accomplish this function.

The decode system, generally denoted 100, of FIG. 5 includes multiple decoders (DECₙ) 110 connected in parallel, wherein in one example, 2≦n≦6. An encoded stream of video data is received via a common host interface 105, and output from the decoders is forwarded to a display buffer 120 from which the assembled picture is displayed 130. Display buffer 120 synchronizes and merges the individual decoders' output into one single display output. An exchange bus structure, including a command bus (CMD) and a data bus (DATA), is shown between adjacent decoders to allow data transfers therebetween as described below. The display buffer is shown as a single entity outside the individual decoders. Alternatively, the buffer may be subdivided by the number of decoders in the system and each subset of the buffer may be integrated within the respective decoder.

As one example, the common host interface 105 is used to program a unique decoder id into each decoder in the configuration. It can also be used to specify to each decoder the total number of decoders in the system. This information is used (in one embodiment) by each decoder to determine its respective portion of a frame to be decoded. Interface 105 is also used to input the complete bitstream (which in one embodiment comprises an HD bitstream) to all decoders simultaneously. The HD bitstream is delivered to the decoders as the input buffer of each decoder becomes available.

As explained further below, all decoders 110 parse the same bitstream and extract common control information from the headers for subsequent decoding use. During the decode process, the decoders 110 obtain the picture dimensions from the sequence header. This picture size is transformed by each decoder to determine the total number of macroblock rows in the picture, and the number of macroblock rows to be processed by each decoder of the system.

For example, let x=picture vertical size/16N, where N is the total number of decoders in the system. Each decoder will process X macroblock rows, with the remainder rows being distributed amongst the decoders, starting in one embodiment from the last or bottom decoder.

In one example, the picture size is 1920×1088 pixels, and thus there are 1088 vertical picture lines or 68 macroblock rows. The first four decoders would be responsible for 11 macroblock rows each, and the last 2 decoders would be responsible for 12 macroblocks rows each. There may be multiple slices on a macroblock row, with each decoder in one embodiment handling all slices of a given row. As a decoder processes a bitstream, it discards slices that it is not responsible for, decoding only the slices within its domain, until the end of the picture is reached. In one aspect, this technique allows multiple SD decoders to share the workload of a single HD decoder.

The following equations represent one embodiment for calculating the number of macroblock rows for a particular decoder to decode:

Let:

M=Number of macroblock rows for decoder n to decode,

M_{B}=Base number of macroblock rows each decoder in the system will decode,

e=additional row for decoder n to decode,

M_{E}=Number of additional macroblock rows,

R=Number of macroblock rows in the HD picture, and

N=Number of SD decoders in the system.

The base number of macroblock rows for each decoder (MB) and the number of additional macroblock rows (ME) are respectfully determined in one embodiment by equations (1) & (2):

M_{B}=R/N where / is an integer divide (1)

M_{E}=R%N where % is modulo divide (i.e., remainder of division) (2)

wherein n=decoder index, where n ranges from 1 to 6

The additional row for encoder n to decode (e) is defined as:

e=1 if (n+M_{E})>N, else e=0 (3)

Thus, the number of macroblock rows for decoder n to decode would be:

M=M_{B}+e (4)

Calculation of a first macroblock row for decoder n to decode can be defined as:

$$If n = 1 then {I}_{n} = 1 , else {I}_{n} = ( {\sum }_{i = 1}^{i = n - 1} {M}_{i} ) + 1 \qquad ( 5 )$$

Wherein:

Iₙ=index of the first macroblock row for decoder n to decode; and

Mᵢ=number of macroblock rows for decoder n to decode (see equation 4)

A high definition stream may be generated by a single encoder, thus motion vectors may point to pixels outside the picture segment of an individual decoder. Since the picture segment in this design is partitioned horizontally, the possible pixels outside of a segment are either vertically to the top or bottom of the segment. The reference picture portion stored in each decoder frame memory should include both its decoded segment and this “motion overlap” region. In one design, at the end of every reference frame (I or P) decoded, the overlap region can be retrieved from the neighboring decoders via the transfer data busses. The maximum vertical motion vector displacement is defined in the MPEG standard as +/−128 full frames. This defines the maximum number of pixel lines to be retrieved from a neighboring decoder.

The decoders in this configuration start decoding simultaneously and thus synchronize at overlap region exchange times to assure proper reference picture data transfer between decoders. Each decoder in the system outputs its decoded data for picture display. The VR and HR are received by all decoder chips and each is knowledgeable of when to output picture data during the display process by virtue of its decoder id. The display out is sequentially armed by all decoder outputs and appears as one cohesive output interface at the system level.

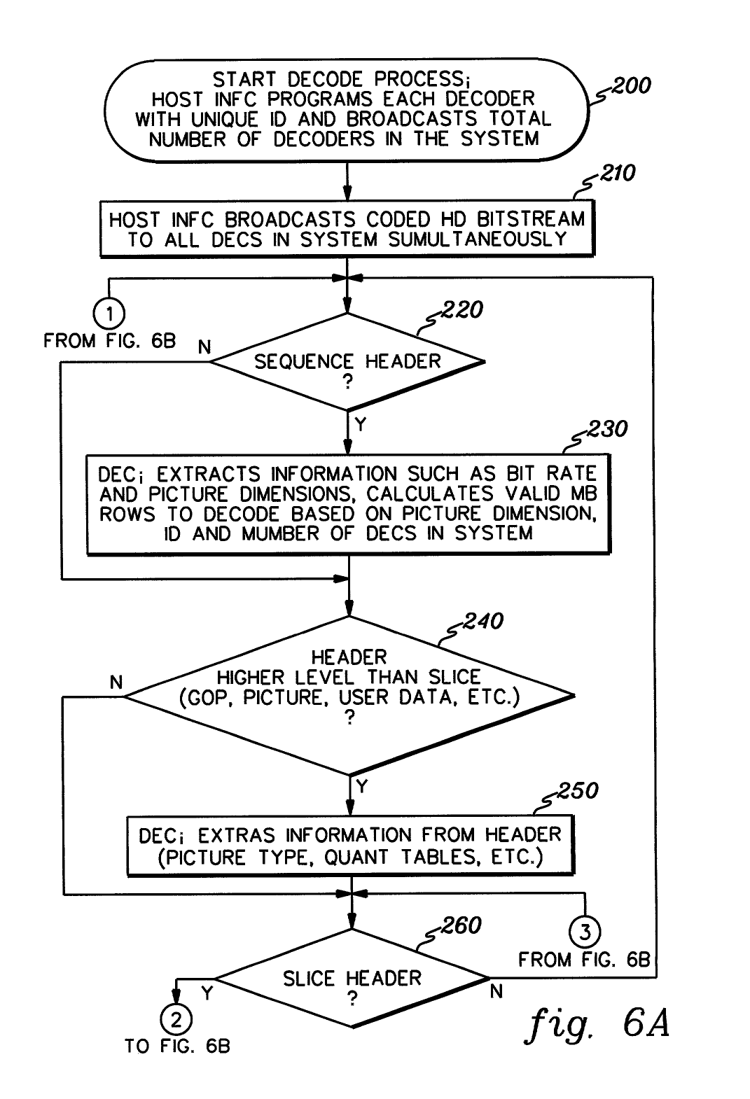

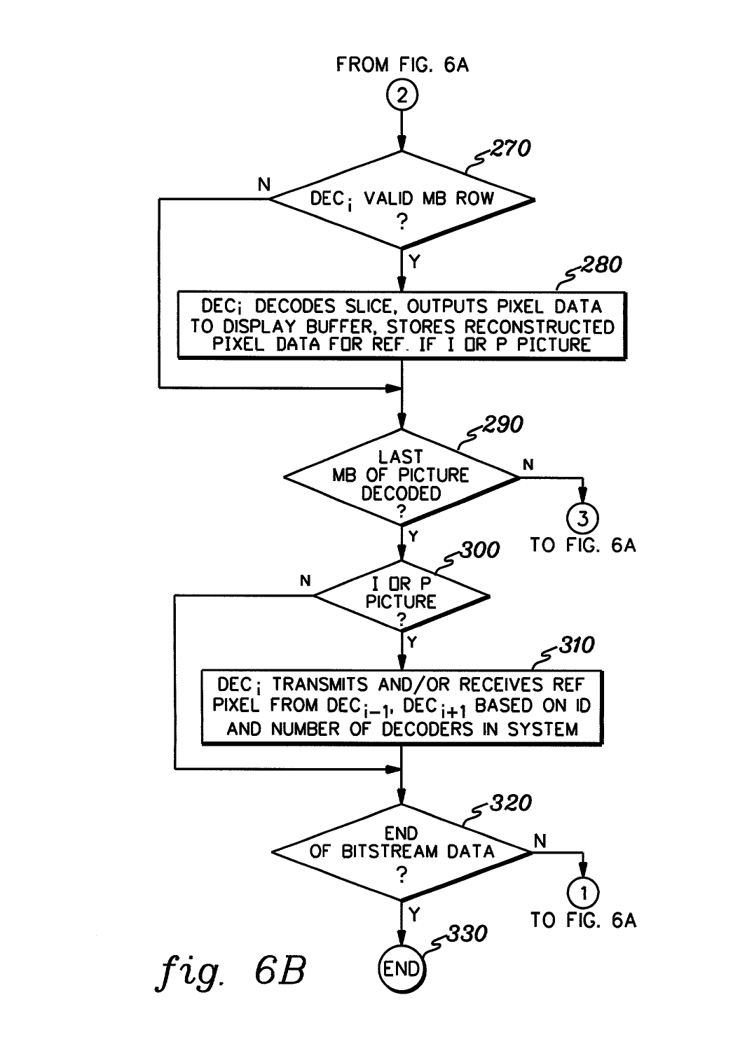

FIGS. 6A & 6B depict one embodiment of a decode process flow in accordance with an aspect of the present invention.

Beginning with FIG. 6A, upon initiation of the decode process, the host interface programs each decoder with a unique decoder id and broadcasts a total number of decoders in the decode system 200. The host interface also broadcasts the coded stream of video frames, which in one embodiment may comprise a high definition bitstream, to all decoders in the system simultaneously 210. Each decoder receives the stream of video frames and inquires whether a sequence header is obtained 220. If so, then the decoder (DECᵢ) extracts information such as bit rate and picture dimensions from the sequence header, and calculates the valid macroblock rows to decode based on picture dimension, its id and the number of decoders in the system 230. After considering the sequence header, the decoders continue to examine the bitstream for other headers, such as a GOP header, picture header, or user data, etc. 240, extracting what common information they need to decode and reconstruct the video sequence 250.

Upon encountering a slice header 260, each decoder determines whether the data comprises a valid macroblock row number 270 (see FIG. 6B) to that decoder. Depending on macroblock row number, the decoder will either receive and decode the slice (280) or discard it. After decoding a slice, the decoder outputs pixel data to the display buffer, and stores reconstructive pixel data for reference if the frame is an I or P frame. The process continues until the last macroblock of the frame has been decoded 290.

After the last slice of the picture is received and decoded or discarded, processing determines whether the frame was an I or P frame 300. If so, the decoders will exchange a portion of their stored reconstructed pixel data based on decoder id and number of decoders in the system 310. Again, this exchange of pixel data is determined by picture type. Only I and P pictures are stored as reconstructive reference pictures, so exchanges need only occur for these pictures. The amount of data swapped is based on picture size and search range. This exchange is necessary so that portions of the picture that are outside of the individual decoder's range are available as reference data to resolve motion vectors which point to these individual, out-of-range regions.

At the end of the bitstream data 320, processing terminates 330.

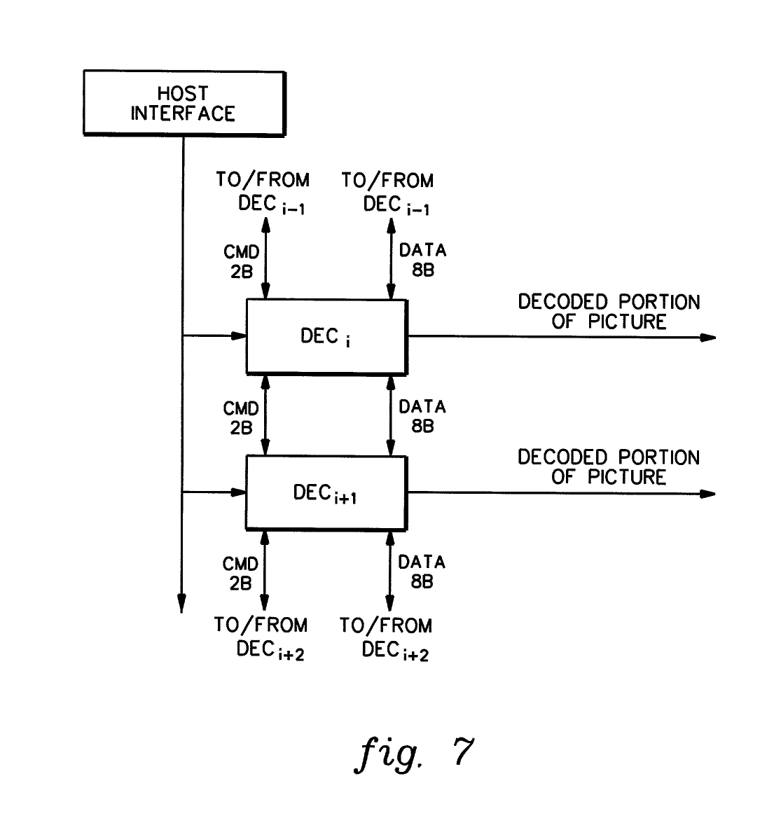

Exchange of pixel data between adjacent decoders is described further below with reference to FIGS. 7-9B.

FIG. 7 depicts in greater detail one embodiment of exchange interface bussing between two adjacent decoders DECᵢ and DECᵢ₊₁ in a decode system such as described herein. In this embodiment, the decoders are assumed to comprise standard definition (SD) decoders. SD decoder communication busses CMD and DATA are shown which allow data transfer, such as transfer of overlapping pixel data, between the adjacent decoders. As one example, a 2 bit bidirectional command bus (CMD) in an 8 bit bidirectional data bus (DATA) supply the necessary means of communication between the adjacent decoders. Also shown are the common host-interface bus and the decoder outputs. As shown, DECᵢ communicates with both DECᵢ₋₁ and DECᵢ₊₁. The location of the decoder in the multiple decoder architecture determines whether a decoder communicates with one or two adjacent decoders. That is, the decoders on the end of a parallel arranged plurality of decoders only have one adjacent decoder and thus only exchange data with that one adjacent decoder.

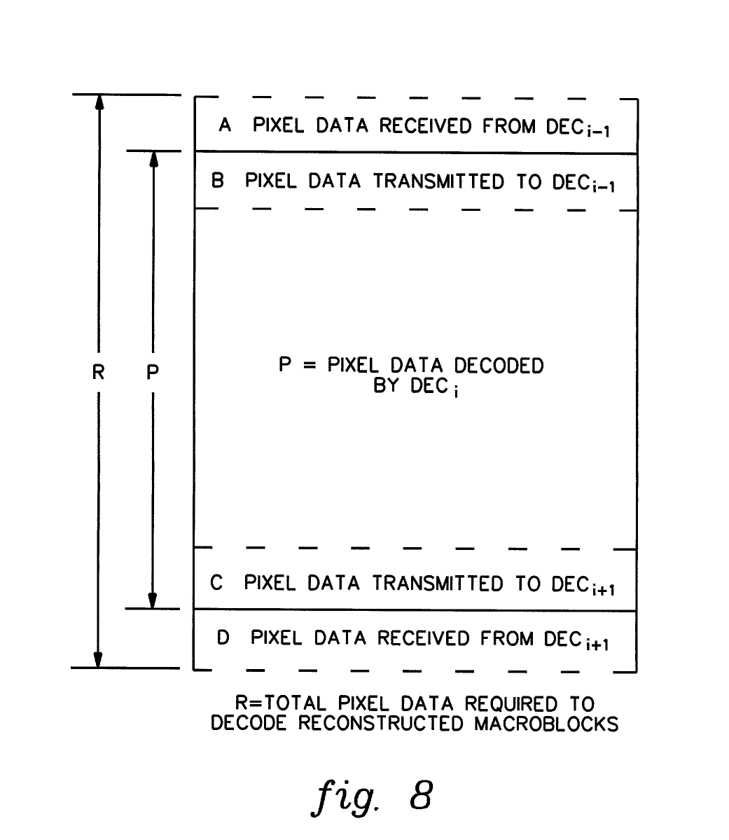

Each decoder stores its own reference data in associated memory such as an SDRAM (not shown). By way of example, the reference data for each decoder may comprise one past reference frame and one future reference frame. As noted above, as a result of decoding a high definition picture by multiple decoders, reference pixel data needs to be exchanged between adjacent decoders to resolve motion vectors that point into regions of the HD picture decoded by these adjacent decoders. For example, in FIG. 8, a section of a frame P is shown representative of the actual pixel data decoded and stored by decoder DECᵢ. The variable R represents the entire amount of an HD picture stored by DECᵢ and used to fetch pixel data pointed to by motion vectors decoded by DECᵢ. Thus, the following data is exchanged between adjacent decoders in one embodiment:

A represents the pixel data received from DECᵢ₋₁ and stored by DECᵢ.

B represents the pixel data transmitted to and stored by DECᵢ₋₁.

C represents the pixel data transmitted to and stored by DECᵢ₋₁.

D represents the pixel data received from DECᵢ₊₁ and stored by DECᵢ.

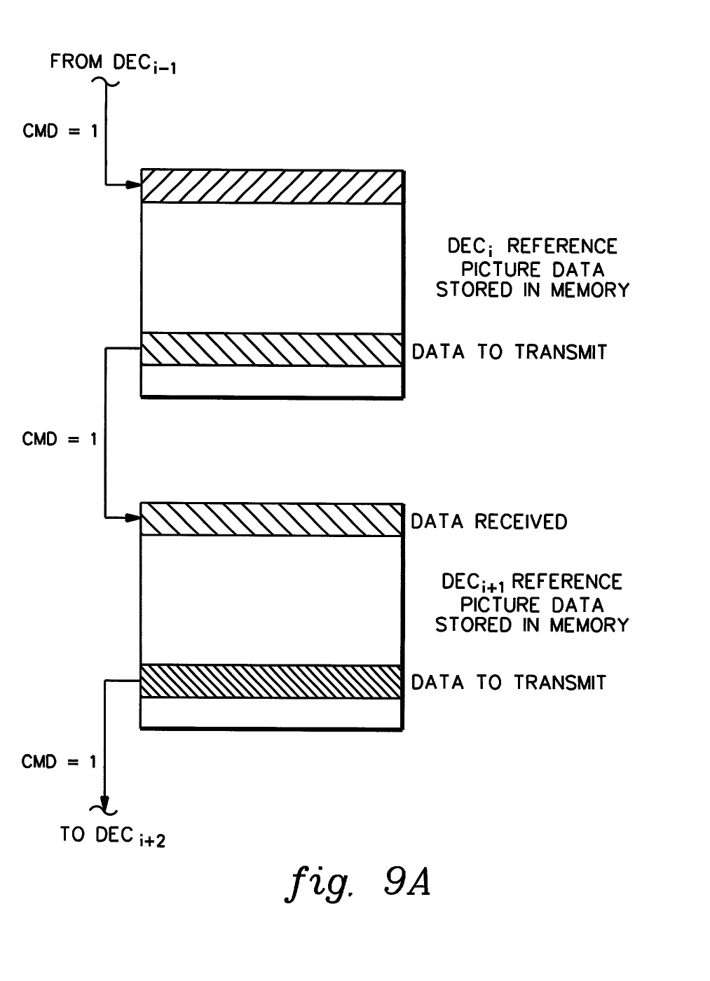

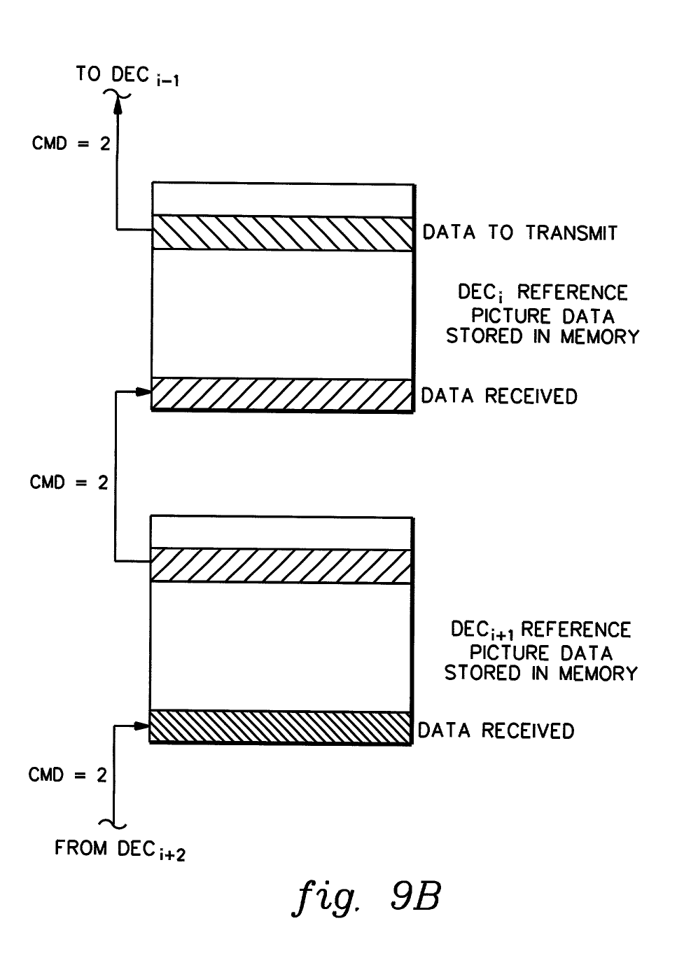

FIGS. 9A & 9B depict one technique for exchanging data between adjacent decoders. As shown in FIG. 9A, if the 2 bit command bus CMD is set to a binary ‘01’, decoders are set up to receive pixel exchange data for the top portion of their respective section R of the reference frame, and transmit pixel exchange data from the bottom of their respective portion of the reference frame. Thus, DECᵢ receives data from DECᵢ₋₁, and transmits data to DECᵢ₋₁, while DECᵢ₊₁ receives data from DECᵢ and transmits data to DECᵢ₊₂.

As shown in FIG. 9B, with the 2 bit command bus CMD set to a binary ‘10’, the decoders are set up to transmit pixel exchange data from the upper section of their respective portion of the reference frame, and receive pixel exchange data for the lower section of their respective portion of the reference frame. Thus, DECᵢ transmits data to DECᵢ₋₁, and receives data from DECᵢ₊₁. Decoder DECᵢ₊₁, in addition to transmitting data to DECᵢ, receives data from DECᵢ₊₂.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of decoding a frame of an encoded stream of video frames, said method comprising:
forwarding an encoded stream of video frames to multiple decode processes in parallel;
decoding at least one frame of the encoded stream of video frames employing the multiple decode processes; and
wherein for each frame of said at least one frame, each decode process of the multiple decode processes selects and decodes a respective portion of the frame, and wherein cumulatively the respective portions decoded by the multiple decode processes comprise the entire frame.

2. The method of claim 1, wherein for each frame of said at least one frame, each decode process of said multiple decode processes discards portions of the frame being decoded outside of its respective portion to decode.

3. The method of claim 1, wherein said forwarding comprises forwarding the encoded stream of video frames to the multiple decode processes in parallel without preprocessing the encoded stream of video frames to facilitate decoding thereof by the multiple decode processes.

4. The method of claim 3, wherein said decoding the at least one frame of the encoded stream of video frames by the multiple decode processes occurs in realtime in a single pass of each frame through the multiple decode processes.

5. The method of claim 1, wherein the multiple decode processes comprise multiple decoders connected in parallel, each decoder comprising a standard definition decoder, and wherein the encoded stream of video frames comprises a high definition signal to be decoded.

6. The method of claim 1, wherein said decoding the at least one frame comprises decoding each frame of the encoded stream of video frames employing the multiple decode processes.

7. The method of claim 1, further comprising exchanging motion overlap data between decode processes of the multiple decode processes decoding adjacent respective portions of the frame.

8. The method of claim 7, wherein said exchanging occurs upon decoding the frame when the frame comprises an I frame or P frame.

9. The method of claim 8, further comprising storing by each decode process its respective portion of the decoded frame when the frame comprises an I frame or P frame.

10. The method of claim 7, wherein said exchanging further comprises synchronizing processing between said multiple decode processes.

11. The method of claim 1, wherein said decoding comprises parsing by each decode process, the encoded stream of video frames to extract time and control information from headers contained therein for subsequent use in decoding the respective portion of the frame.

12. The method of claim 11, wherein the respective portion of the frame decoded by each decode process comprises a respective number of macroblock rows of the frame, and wherein each decode process automatically determines which macroblock rows of said frame comprise its respective portion of the frame to be decoded.

13. The method of claim 1, wherein said decoding comprises sequentially decoding by the multiple decode processes their respective portions of the frame as the encoded stream of video frames passes through the multiple decode processes.

14. The method of claim 13, further comprising outputting from the decode processes their respective decoded portions of the frame to a display buffer, said display buffer facilitating display of the entire decoded frame.

15. A system for decoding a frame of an encoded stream of video frames, said system comprising:
means for forwarding an encoded stream of video frames to multiple decode processes in parallel;
means for decoding at least one frame of the encoded stream of video frames employing the multiple decode processes; and
wherein for each frame of said at least one frame, each decode process of the multiple decode processes comprises means for selecting and for decoding a respective portion of the frame, and wherein cumulatively the respective portions decoded by the multiple decode processes comprise the entire frame.

16. The system of claim 15, wherein for each frame of said at least one frame, each decode process of said multiple decode processes comprises means for discarding portions of the frame being decoded outside of its respective portion to decode.

17. The system of claim 15, wherein said means for forwarding comprises means for forwarding the encoded stream of video frames to the multiple decode processes in parallel without preprocessing the encoded stream of video frames to facilitate decoding thereof by the multiple decode processes.

18. The system of claim 17, wherein said means for decoding the at least one frame of the encoded stream of video frames by the multiple decode processes occurs in realtime in a single pass of each frame through the multiple decode processes.

19. The system of claim 15, wherein the multiple decode processes comprise multiple decoders connected in parallel, each decoder comprising a standard definition decoder, and wherein the encoded stream of video frames comprises a high definition signal to be decoded.

20. The system of claim 15, wherein said means for decoding the at least one frame comprises means for decoding each frame of the encoded stream of video frames employing the multiple decode processes.

21. The system of claim 15, further comprising means for exchanging motion overlap data between decode processes of the multiple decode processes decoding adjacent respective portions of the frame.

22. The system of claim 21, wherein said means for exchanging occurs upon decoding the frame when the frame comprises an I frame or P frame.

23. The system of claim 22, further comprising means for storing by each decode process its respective portion of the decoded frame when the frame comprises an I frame or P frame.

24. The system of claim 21, wherein said means for exchanging further comprises means for synchronizing processing between said multiple decode processes.

25. The system of claim 15, wherein said means for decoding comprises means for parsing by each decode process, the encoded stream of video frames to extract time and control information from headers contained therein for subsequent use in decoding the respective portion of the frame.

26. The system of claim 25, wherein the respective portion of the frame decoded by each decode process comprises a respective number of macroblock rows of the frame, and wherein each decode process comprises means for automatically determining which macroblock rows of said frame comprise its respective portion of the frame to be decoded.

27. The system of claim 15, wherein said means for decoding comprises means for sequentially decoding by the multiple decode processes their respective portions of the frame as the encoded stream of video frames passes through the multiple decode processes.

28. The system of claim 27, further comprising means for outputting from the decode processes their respective decoded portions of the frame to a display buffer, said display buffer facilitating display of the entire decoded frame.

29. A system for decoding a frame of an encoded stream of video frames, said system comprising:
a host interface for receiving and forwarding an encoded stream of video frames;
multiple decoders connected in parallel for decoding at least one frame of the encoded stream of video frames; and
wherein said host interface forwards the encoded stream of video frames simultaneously to said multiple decoders, and wherein for each frame of said at least one frame, each decoder selects and decodes a respective portion of the frame, and wherein cumulatively the respective portions decoded by the decoders comprise the entire frame.

30. At least one program storage device readable by a machine, tangibly embodying at least one program of instructions executable by the machine to perform a method of decoding a frame of an encoded stream of video frames, comprising:
forwarding an encoded stream of video frames to multiple decode processes in parallel;
decoding at least one frame of the encoded stream of video frames employing the multiple decode processes; and
wherein for each frame of said at least one frame, each decode process of the multiple decode processes selects and decodes a respective portion of the frame, and wherein cumulatively the respective portions decoded by the multiple decode processes comprise the entire frame.
